(19) United States
(12) Patent Application Publication
(10) Pub. No.: US 2026/0189512 A1
(43) Pub. Date: Jul. 2, 2026

(54) CONGESTION WINDOW CONTROL BASED ON DRIVING CONDITIONS

(71) Applicant: TOYOTA MOTOR ENGINEERING & MANUFACTURING NORTH AMERICA, INC., PLANO, TX (US)

(72) Inventors: CHUNGHAN LEE, Mountain View, CA (US); SEYHAN UCAR, Mountain View, CA (US); ONUR ALTINTAS, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/005,658

(22) Filed: Dec. 30, 2024

(51) Int. Cl. H04L 47/27; H04W 4/46

(52) U.S. Cl. CPC H04L 47/27; H04W 4/46

(57) ABSTRACT

Systems and methods are provided for adjusting congestion window size in response to detecting or predicting changes in driving conditions. For example, a method of the presently disclosed technology may involve: (1) detecting or predicting a change in positional relationship between a first vehicle and a second vehicle; (2) based on the detected or predicted change in positional relationship, predicting a change in throughput for a wireless communication link between the first vehicle and the second vehicle; and (3) based on the predicted change in throughput, adjusting size of a congestion window for the wireless communication link.

### TECHNICAL FIELD

The present disclosure relates generally to automotive systems and technologies. More particularly, some embodiments relate to adjusting congestion window size in response to detecting or predicting changes in driving conditions.

### DESCRIPTION OF RELATED ART

Vehicle-to-everything (V2X) networks enable vehicles to communicate wirelessly via one or more communication protocols. V2X networks can include vehicle-to-vehicle (V2V) networks, vehicle-to-infrastructure (V2I) networks, vehicle-to-network (V2N) networks, or any combination thereof.

As an example of V2X communication, two vehicles may establish a wireless communication link (e.g., a TCP connection) to transmit data.

Congestion control algorithms attempt to determine an optimal rate for sending traffic/packets over a wireless communication link by balancing throughput (i.e., the rate of data delivery) and congestion (i.e., reduced service quality that occurs when a wireless communication link is carrying more data than it can handle). Such a determination typically involves monitoring and adjusting congestion window size in response to network metrics (e.g., round-trip-time (RTT), packet loss, packet delay, etc.).

Congestion control algorithms can control congestion by reducing size of a congestion window (as used herein a congestion window may refer to a number of unacknowledged packets that can be outstanding/in transit end-to-end). However, reducing congestion window size also tends to reduce throughput for a wireless communication link. Conversely, increasing congestion window size can increase throughput, at a cost of increased congestion—potentially overflowing queues and reducing performance. Accordingly, a goal of congestion control is to achieve optimal tuning of congestion window size to effectively balance throughput and congestion.

### BRIEF SUMMARY OF THE DISCLOSURE

According to various embodiments of the presently disclosed technology, a method is provided. The method may comprise: (1) detecting or predicting a change in positional relationship between a first vehicle and a second vehicle; (2) based on the detected or predicted change in positional relationship, predicting a change in throughput for a wireless communication link between the first vehicle and the second vehicle; and (3) based on the predicted change in throughput, adjusting size of a congestion window for the wireless communication link.

In some embodiments of the method, the change in positional relationship between the first vehicle and the second vehicle may comprise at least one of: (a) a change in positional relationship that hinders a line of sight between the first vehicle and the second vehicle; (b) over a threshold increase in distance between the first vehicle and the second vehicle; and (c) at least one of the first vehicle and the second vehicle transitioning from a stationary state to a moving state. Here, the change in positional relationship that hinders the line of sight between the first vehicle and the second vehicle may comprise at least one of: (i) a third vehicle merging in between the first vehicle and the second vehicle; and (ii) over a threshold change in heading for the first vehicle relative to a heading of the second vehicle. Predicting the change in throughput for the wireless communication link may comprise predicting a decrease in throughput. Relatedly, adjusting size of the congestion window may comprise decreasing size of the congestion window.

In certain embodiments of the method, the method may further comprise: (1) after adjusting the size of the congestion window, detecting the first vehicle and the second vehicle have both come to stationary states, are within a threshold distance of each other, and have an unobstructed line of sight to each other; and (2) responsive detecting the first vehicle and the second vehicle have both come to stationary states, are within the threshold distance of each other, and have an unobstructed line of sight to each other: controlling size of the congestion window in accordance with a default congestion control algorithm of a communication protocol governing the wireless communication link. In some of these embodiments, the communication protocol may comprise a congestion control-based network protocol (e.g., TCP, HTTP, QUIC, GRPC, MQTT, etc.). In various of such embodiments, controlling size of the congestion window in accordance with the default congestion control algorithm may comprise increasing size of the congestion window.

In some embodiments of the method, detecting or predicting the change in positional relationship between the first vehicle and the second vehicle may comprise predicting the change in positional relationship based on at least one of: (a) intent messages from at least one of the first vehicle, the second vehicle, and a third vehicle predicted to merge in between the first vehicle and the second vehicle; (b) detected driving behavior of at least one of the first vehicle, the second vehicle, and the third vehicle; and (c) navigation data from at least one of the first vehicle and the second vehicle. In certain of these embodiments, at least two of the first vehicle, the second vehicle, and the third vehicle may form a vehicular micro-cloud (VMC) and the intent messages may be transmitted among members of the VMC.

According to certain embodiments of the presently disclosed technology, a vehicle is provided. The vehicle may comprise: (1) one or more processors; and (2) memory storing machine-readable instructions that, when executed by the one or more processors, cause the vehicle to: (a) establish a wireless communication link with a second vehicle; (b) detect or predict a change in positional relationship between the vehicle and the second vehicle; (c) based on the detection or prediction, adjust size of a congestion window for the wireless communication link; and (d) transmit packets to the second vehicle over the wireless communication link in accordance with the adjusted size of the congestion window.

In some embodiments of the vehicle, the change in positional relationship between the vehicle and the second vehicle may comprise at least one of: (i) a change in positional relationship that un-obstructs a line of sight between the vehicle and the second vehicle; (ii) over a threshold decrease in distance between the vehicle and the second vehicle; and (iii) the vehicle and the second vehicle transitioning from moving states to stationary states. Relatedly, adjusting size of the congestion window may comprise at least one of: (i) increasing size of the congestion window; and (ii) reducing a rate of decrease in size for the congestion window.

In various embodiments of the vehicle, the memory may store further instructions, that when executed by the one or more processors, cause the vehicle to, based on the detected or predicted change in positional relationship between the vehicle and the second vehicle, predict a change in throughput for the wireless communication link. Here, adjusting size of the congestion window can be based on the predicted change in throughput.

According to certain embodiments of the presently disclosed technology, a system is provided. The system may comprise: (1) one or more processors; and (2) memory storing machine-readable instructions that, when executed by the one or more processors, cause the system to: (a) detect or predict a change in positional relationship between a first vehicle and a second vehicle; (b) based on the detected or predicted change in positional relationship, predict a change in throughput for a wireless communication link between the first vehicle and the second vehicle; and (c) based on the predicted change in throughput for the wireless communication link, adjust size of a congestion window for the wireless communication link.

In some embodiments of the system, the change in positional relationship between the first vehicle and the second vehicle may comprise at least one of: (i) a change in positional relationship that hinders a line of sight between the first vehicle and the second vehicle; (ii) over a threshold increase in distance between the first vehicle and the second vehicle; and (iii) at least one of the first vehicle and the second vehicle transitioning from a stationary state to a moving state. Here, the change in positional relationship that hinders the line of sight between the first vehicle and the second vehicle may comprise at least one of: (A) a third vehicle merging in between the first vehicle and the second vehicle; and (B) over a threshold change in heading for the first vehicle relative to a heading of the second vehicle. Predicting the change in throughput for the wireless communication link may comprise predicting a decrease in throughput. Relatedly, adjusting size of the congestion window may comprise decreasing size of the congestion window.

In various embodiments of the system, the change in positional relationship between the first vehicle and the second vehicle may comprise at least one of: (i) a change in positional relationship that un-hinders a line of sight between the first vehicle and the second vehicle; (ii) over a threshold decrease in distance between the first vehicle and the second vehicle; and (iii) the first vehicle and the second vehicle transitioning from moving states to stationary states. Here, predicting the change in throughput for the wireless communication link may comprise predicting an increase in throughput. Relatedly, adjusting size of the congestion window may comprise at least one of: (A) increasing size of the congestion window; and (B) reducing a rate of decrease in size for the congestion window.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict example embodiments.

FIGS. 1A-1B illustrate an example road segment over which embodiments of the presently disclosed technology may be implemented.

FIG. 2 illustrates an example vehicle, in accordance with various embodiments of the presently disclosed technology.

FIG. 3 illustrates an example implementation of a congestion control system, in accordance with various embodiments of the presently disclosed technology.

FIG. 4 illustrates an example process that may be performed by a congestion control system to adjust congestion window size in response to detecting or predicting changes in driving conditions, in accordance with various embodiments of the presently disclosed technology.

FIG. 5 illustrates another example process that may be performed by a vehicle to adjust congestion window size in response to detecting or predicting changes in driving conditions, in accordance with various embodiments of the presently disclosed technology.

FIG. 6 illustrates a plot of example test data correlating throughput of a wireless communication link between two vehicles, in accordance with various embodiments of the presently disclosed technology.

FIG. 7 illustrates an example graph illustrating how a congestion control system of the presently disclosed technology may adjust congestion window size over time in response to detecting or predicting changes in driving conditions.

FIG. 8 is an example computing component that may be used to implement various features of embodiments described in the present disclosure.

The figures are not exhaustive and do not limit the present disclosure to the precise form disclosed.

### DETAILED DESCRIPTION

Throughput for a wireless communication link between two vehicles can vary significantly based on driving conditions. For example, throughput for the wireless communication link may be highest when the two vehicles are relatively stationary (e.g., fully stationary or moving below a threshold velocity) and have an un-hindered/un-obstructed line of sight to each other. Throughput for the wireless communication also generally increases with increasing proximity between the two vehicles.

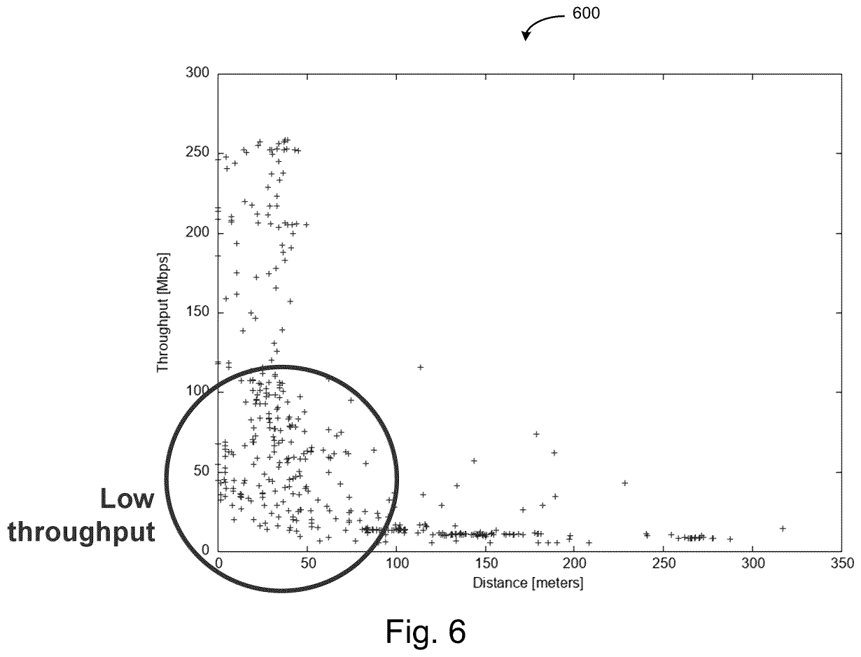

As an example, FIG. 6 illustrates a plot 600 of example test data correlating throughput of a wireless communication link between two vehicles (plotted on the y-axis) as a function of distance (plotted on the x-axis) between the two vehicles. As shown in plot 600, throughput generally increases with increasing proximity between the two vehicles. However, in certain cases throughput may remain low when the two vehicles are close together. This may be the case when a line of sight between the two vehicles is hindered (e.g., because a third vehicle is obstructing the line of sight, or headings of the vehicles are different such as when one vehicle corners a turn before the other vehicle). This may also be the case when the two vehicles are moving, or more acutely, moving away from each other.

As alluded to above, congestion control algorithms can control size of a congestion window to facilitate higher or lower throughput for a wireless communication link. Namely, increasing congestion window size may facilitate increased throughput—and vice versa. However (and as alluded to above), various driving conditions can impact throughput for a wireless communication link independent from congestion window size.

In general, network resources are more efficiently utilized when a congestion window is sized appropriately in view of throughput-impacting driving conditions. For example, a larger than appropriate congestion window size for a low throughput driving condition (e.g., where a line of sight between communicating vehicles is obstructed) can lead to an inefficient use of network resources, increased congestion, etc. As another example, a smaller than appropriate congestion window size for a high throughput driving condition (e.g., where the line of sight between the communicating vehicles becomes un-obstructed) may place an unnecessary cap on throughput that would otherwise be enabled.

Existing V2X technologies generally control congestion window size using default congestion control algorithms for an applicable communication protocol (e.g., the TCP congestion control algorithm for a TCP connection). As alluded to above, standard/default congestion control algorithms generally monitor and adjust congestion window size in response to network metrics (e.g., RTT, packet loss, packet delay, etc.). Technologies that use non-standard/non-default congestion control algorithms also generally monitor and adjust congestion window size in response to network metrics.

However, monitored network metrics often lag behind real-time changes in throughput-impacting driving conditions. For example, there may be a time lag between: (a) when a line of sight becomes obstructed between two vehicles, and (b) when monitored network metrics (e.g., RTT, packet loss, packet delay, etc.) indicate a reduction in throughput for a wireless communication link between the two vehicles. Relatedly, there may be another time lag between: (a) when the line of sight becomes un-obstructed, and (b) when monitored network metrics (e.g., RTT, packet loss, packet delay, etc.) indicate an increase in throughput for the wireless communication link.

Accordingly, conventional technologies that monitor and adjust congestion window size in response to network metrics may react more slowly than optimal to changes in throughput-impacting driving conditions. For example, size of a congestion window may be maintained at a high level for longer than optimal in view of a reduction in throughput for a wireless communication link between two vehicles (e.g., caused by a third vehicle merging in-between the two vehicles) - which can be inefficient use of channel/bandwidth resources. As another example, size of a congestion window may be maintained at a low level for longer than optimal in view of an increase in throughput for the wireless communication link between (e.g., caused by the third vehicle moving to un-hinder/un-obstruct the line of sign between the two vehicles)—which may place an unnecessary cap on throughput that would otherwise be enabled.

Against this backdrop, systems and methods of the presently disclosed technology provide enhanced congestion control for wireless communication links between vehicles by adjusting congestion window size in response to detected or predicted changes in throughput-impacting driving conditions.

For example, a system of the presently disclosed technology (e.g., a cloud-based system, and roadside infrastructure-based system, a vehicle-based system, or a combination thereof) may be configured to detect or predict a change in positional relationship between a first vehicle and a second vehicle. The detected/predicted change in positional relationship may correspond with a change in throughput-impacting driving conditions. For example, the detected/predicted change in positional relationship may involve a third vehicle merging between the first and second vehicles—thus hindering/obstructing a line of sight between the first and second vehicles.

Based on the detected or predicted change in positional relationship, the system can predict a change in throughput for a wireless communication link between the first vehicle and the second vehicle. For example, if the detected/predicted change in positional relationship involves a third vehicle merging between the first and second vehicles, the system may predict a decrease in throughput for the wireless communication link due to the detected/predicted line of sight obstruction between the first and second vehicles.

Accordingly, based on the predicted change in throughput, the system can adjust size of a congestion window for the wireless communication link. For example, if the system predicts a decrease in throughput, the system may decrease size of the congestion window to more appropriately size the congestion window for the predicted decrease in throughput.

Importantly, the system may react more quickly to detected/predicted changes in throughput-impacting driving conditions than alternative/conventional technologies that adjust congestion window size based on monitored network metrics. As alluded to above, monitored network metrics often lag behind real-time changes in throughput-impacting driving conditions. For example, there may be a time lag between: (a) when a line of sight becomes obstructed between two vehicles, and (b) when monitored network metrics (e.g., RTT, packet loss, packet delay, etc.) indicate a reduction in throughput for a wireless communication link between the two vehicles. Relatedly, there may be another time lag between: (a) when the line of sight becomes un-obstructed, and (b) when monitored network metrics (e.g., RTT, packet loss, packet delay, etc.) indicate an increase in throughput for the wireless communication link.

Accordingly, by adjusting congestion window size in response to detected changes in throughput-impacting driving conditions, the system can react more quickly to the detected change in throughput-impacting driving conditions than alternative/conventional technologies that adjust congestion window size based on monitored network metrics.

Moreover (and as alluded to above), in certain implementations the system may react even more quickly by predicting changes in throughput-impacting driving conditions before they occur. The system can use various techniques to predict these changes, such as, analyzing at least one of: (a) intent messages exchanged between vehicles (e.g., indicating a third vehicle intends to merge between two communicating vehicles); (b) detected driving behavior vehicles (e.g., a third vehicle nudging into a lane between two communicating vehicles, operation of a turn signal on the third vehicle indicating an intention to change lanes, etc.); and (c) navigation data of vehicles (e.g., a planned route indicating a first communicating vehicle will likely/imminently turn onto a new street—thus hindering a line of sight between the first communicating vehicle and a second communicating vehicle).

As alluded to above, by reacting more quickly to changes in throughput-impacting driving conditions than alternative/conventional technologies, the system can more appropriately size a congestion window during changes in throughput for a wireless communication link between vehicles. In this way, the system can improve efficiency for channel/bandwidth resources, increase the likelihood that maximum enabled throughout is being utilized, etc. More generally, the system can improve operation of wireless communication hardware and software systems used in vehicles.

Systems and methods of the presently disclosed technology will now be described in conjunction with the following FIGs.

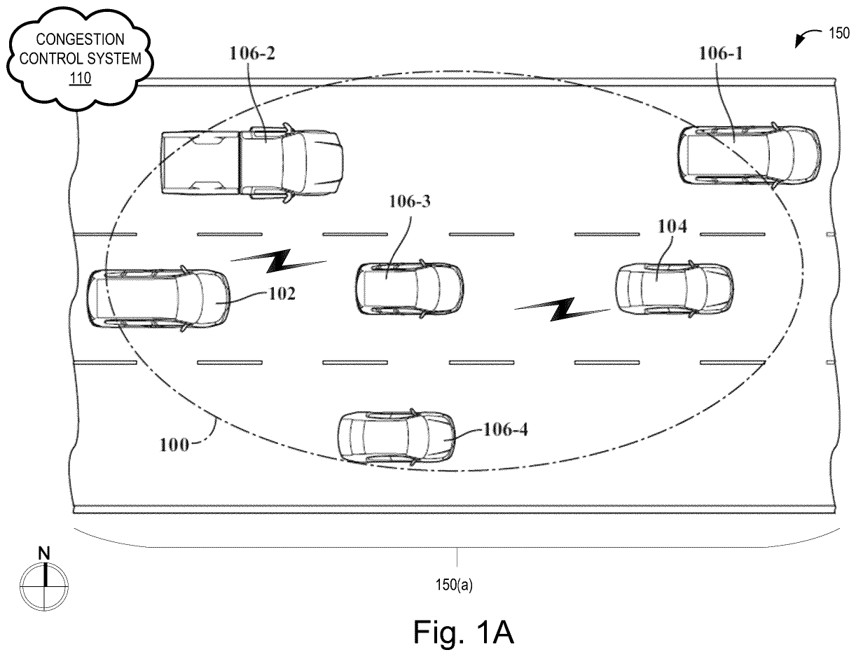

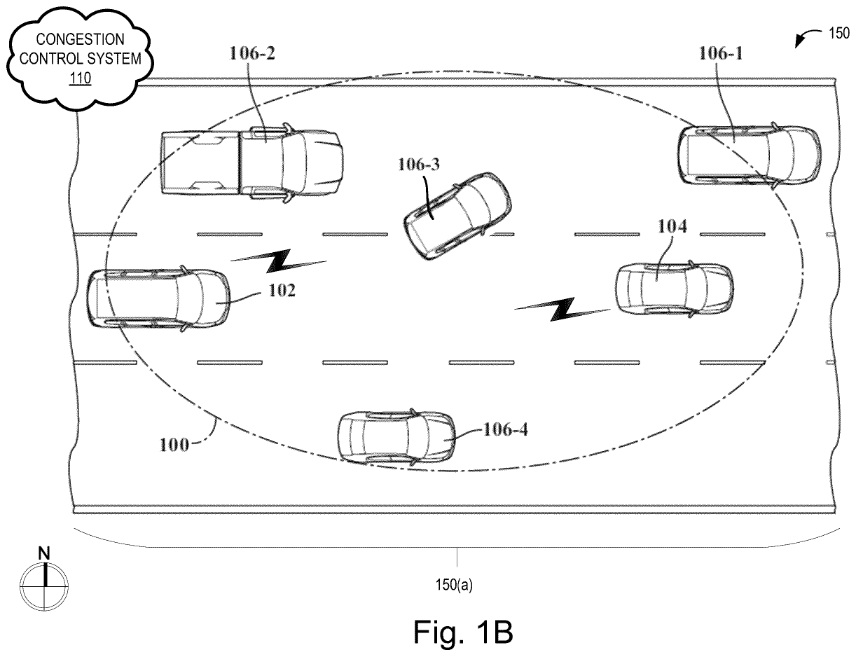

FIGS. 1A and 1B illustrate regions of a road segment 150 over which embodiments of the presently disclosed technology may be implemented.

Namely, FIG. 1A illustrates an example region 150(a) that vehicles 102, 104, 106-1, 106-2, 106-3 and 106-4 traverse at a first time t₁. FIG. 1B illustrates an example region 150(b) that the above-referenced vehicles traverse at a later time t₂.

As depicted, vehicle 102 and vehicle 104 may be communicating over a wireless communication link.

Congestion control system 110 (also depicted in FIGS. 1A-1B) may manage/adjust size of a congestion window for the wireless communication link as vehicles 102 and 104 traverse road segment 150 over time. Congestion control system 110 may comprise a cloud-based system, a system implemented across one or more of the depicted vehicles (and in some cases roadside infrastructure), or a combination thereof.

As alluded to above, congestion control system 110 can manage/adjust congestion window size in response to dynamically changing driving conditions.

For example, at the first time t₁, vehicle 106-3 is obstructing a line of sight between vehicle 102 and vehicle 104. As described above, such an obstruction may generally reduce throughput of the wireless communication link. Accordingly, at the first time t₁, congestion control system 110 may maintain size of the congestion window for the wireless communication link at a relatively low level.

However, at the second time t₂, vehicle 106-3 is in the process of changing lanes—which consequently un-obstructs the line of sight between vehicles 102 and 104. As described above, this change in positional relationship between vehicles 102 and 104 (i.e., the un-obstruction of the line of sight resulting from vehicle 106-3 changing lanes) may increase throughput for the wireless communication link.

Accordingly, congestion control system 110 may increase congestion window size for the wireless communication link in response to detecting vehicle 106-3 is changing lanes. In doing so, congestion control system 110 may react more quickly to this change in throughput-impacting driving conditions than alternative/conventional technologies that adjust congestion window size based on monitored network metrics. For example (and as alluded to above), there may be a time lag between: (a) when vehicle 106-3 changes lanes to un-obstruct the line of sight between vehicles 102 and 104, and (b) when monitored network metrics (e.g., RTT, packet loss, packet delay, etc.) indicate an increase in throughput for the wireless communication link.

Accordingly, by adjusting congestion window size in response to detected changes in throughput-impacting driving conditions, congestion control system 110 can react more quickly to the detected changes in throughput-impacting driving conditions than alternative/conventional technologies that adjust congestion window size based on monitored network metrics.

Moreover (and as alluded to above), in certain implementations congestion control system 110 may react even more quickly by predicting changes in throughput-impacting driving conditions before they occur. For example, in the specific example of FIGS. 1A-1B, congestion control system 110 may predict that vehicle 106-3 will change lanes before the second time t₂. Congestion control system 110 can use various techniques to predict this lane change, such as, analyzing at least one of: (a) intent messages transmitted by vehicle 106-3 (e.g., indicating that vehicle 106-3 intends to change lanes); (b) detected driving behavior vehicle 106-3 (e.g., operation of a left-hand turn signal on vehicle 106-3, vehicle 106-3 nudging into the left lane, etc.); and (c) navigation data from vehicle 106-3 (e.g., navigation data indicating vehicle 106-3's planned route involves a left hand turn at an impending intersection).

By predicting vehicle 106-3's lane change prior to the second time t₂, congestion control system 110 may react even more quickly to this change in driving conditions that increases throughput for the wireless communication link between vehicles 102 and 104.

As alluded to above, in certain implementations two or more of the vehicles depicted in FIGS. 1A-1B may share intent messages with each other and congestion control system 110—which congestion control system 110 can leverage to predict changes in throughput-impacting driving conditions. In some of these implementations, the intent messages may be shared when the two or more vehicles (and in some cases congestion control system 110) form a vehicular micro-cloud (VMC) 100.

A VMC may refer to a group of vehicles that share resources (e.g., sensor resources, processing resources, memory resources, communication resources, etc.) to complete a task.

As an illustrative example, vehicle 102 (referred to hereafter as leader 102) may be a leader of VMC 100. Leader 102 may be a vehicle (or in some cases a piece of roadside infrastructure or more generally a remote server) that manages operation of VMC 100. For example, leader 102 may receive a request for a task to be completed, assign sub-tasks to particular VMC members, receive the output/results of completed sub-tasks, aggregate/combine the output/results of the completed sub-tasks into an output/results of the overall task, and promulgate the output/results of the overall task to VMC members. In the context of the present application, leader 102 may, in some examples, adjust congestion window size for wireless communication links between vehicles of VMC 100.

The following paragraphs describe operation of VMC 100 (as an example of a VMC) more generally.

As described above, through VMC 100, leader 102, vehicle 104, and vehicles 106-1, 106-2, 106-3, and 106-4 can share resources. Examples of shared resources may include sensor resources, processing resources, memory resources, communication resources, network bandwidth resources, etc. Examples of VMC sub-tasks that may be completed by a vehicle in VMC 100 may include executing software, executing calculations, sending/receiving messages or data, finding digital data stored by any member of VMC 100, instructing different members of VMC 100 to help with calculations, etc. Examples of information shared within VMC 100 may include image frames or video feeds from image sensors, image processing results, object detection results from proximity sensors, GPS coordinates, computation results from processing data from sensor sets, etc.

While particular reference is made to particular sub-tasks, various other sub-tasks may be completed by the members of VMC 100. When the various members complete these sub-tasks, leader 102 can provide a resultant/combined output of the sub-tasks to the members of VMC 100. That is, leader 102 (or in some cases a remote server) can aggregate data/output from the members to provide collaborative results relevant to a requested (overall) VMC task. Examples of tasks completed by VMC 100 may include dynamic map generation, cooperative path planning, distributed data storage, etc.

As described above, the members of VMC 100 may communicate using a V2X network that enables vehicles to wirelessly communicate via one or more communication protocols. Examples of V2X networks may include Dedicated Short Range Communication (DSRC) networks used to send Basic Safety Messages (BSMs) and Personal Safety Messages (PSMs), among other types of DSRC communications. Other examples of V2X networks can include Bluetooth® networks; Long-Term Evolution (LTE) networks; millimeter wave (mmWave) networks; 3G networks; 4G networks; 5G networks; Voice over LTE (VoLTE) networks; etc.

As described above, V2X networks can include V2V networks, V2I networks, V2N networks, or any combination thereof.

While particular reference is made to particular communication modalities of VMC 100, the communication network may include other connected paths across which multiple vehicles may communicate including other cellular or mobile communications networks. In other implementations, VMC 100 may comprise a network other than a V2X network. For example, certain V2X networks may not allow members to access and use the unused computing resources of the other endpoints of such networks. By comparison, VMC 100 may allow all members to access and use designated unused computing resources of the other members of VMC 100.

In various implementations, a respective member of VMC 100 can join VMC 100 via a handshake process with a coordinator of VMC 100 (e.g., leader 102 or a remote server). In certain implementations, the memory of a respective member can store member data. The member data may comprise digital data that describes one or more of the following: the identity of each of the members; what digital data, or bits of data, are stored by each member; what computing services are available from each member; what computing resources are available from each member and what quantity of these resources are available; and how to communicate with each member. In some implementations, the member data may also describe logical associations between vehicles.

VMC 100 may comprise various types of VMCs.

For example, VMC 100 may comprise a stationary VMC that is tied to a fixed geographical region. A vehicle can join a stationary VMC and contribute its resources upon entering the fixed geographical region as determined by a GPS sensor of the vehicle. The vehicle may leave the stationary VMC upon exiting from the fixed geographical region. When exiting from the fixed geographical region, the vehicle may hand over ongoing sub-tasks and data of the stationary VMC to other members.

As another example, VMC 100 may comprise a mobile VMC. A mobile VMC may be formed around a particular vehicle (e.g., leader 102) traversing road segment 150. Vehicles within a threshold distance of the particular vehicle can join the mobile VMC via a handshake operation. As the particular vehicle moves, the geographic location of the mobile VMC may change with the movement of the particular vehicle and other members of the mobile VMC. A vehicle can join the mobile VMC when the vehicle is in an area covered by the mobile VMC. The vehicle can leave the mobile VMC when the vehicle exits the area covered by the mobile VMC. Where VMC 100 is a mobile VMC, leader 102 may advertise VMC 100, and vehicles within a threshold distance of leader 102 may join/participate in VMC 100.

As another example, VMC 100 may comprise one of consecutive interdependent VMCs formed along road segment 150. For example, it may be the case that one mobile VMC is not sufficient to carry out a VMC task, such as defining a model of the behavior of vehicles on a particular stretch of the roadway. Accordingly, as leader 102 travels along the roadway, it may pass through different VMCs, and the different VMCs can perform different sub-tasks such that the output of the different VMCs may be used to generate a larger output that spans multiple regions associated with the individual VMCs.

In yet another example, VMC 100 may comprise a remote VMC where an ego vehicle can be connected to other vehicles that are remote from the ego vehicle. In this example, the ego vehicle may be a remote leader and remotely control the collaboration of members. For example, an ego vehicle in one city may want to know the parking availability in a city spaced apart from the city where the ego vehicle is located. In this example, the ego vehicle could form a remote VMC with vehicles in the target city. The vehicles in the target city, using exterior sensors, could indicate parking availability to the ego vehicle.

While particular types of VMCs are described herein, different types of VMCs 100 may be implemented in accordance with the principles described herein.

As described above, VMC 100 may include leader 102 that initiates formation of VMC 100 and otherwise manages VMC 100. In the context of the present application, leader 102 may, in some examples, adjust congestion window size for wireless communication links between vehicles of VMC 100.

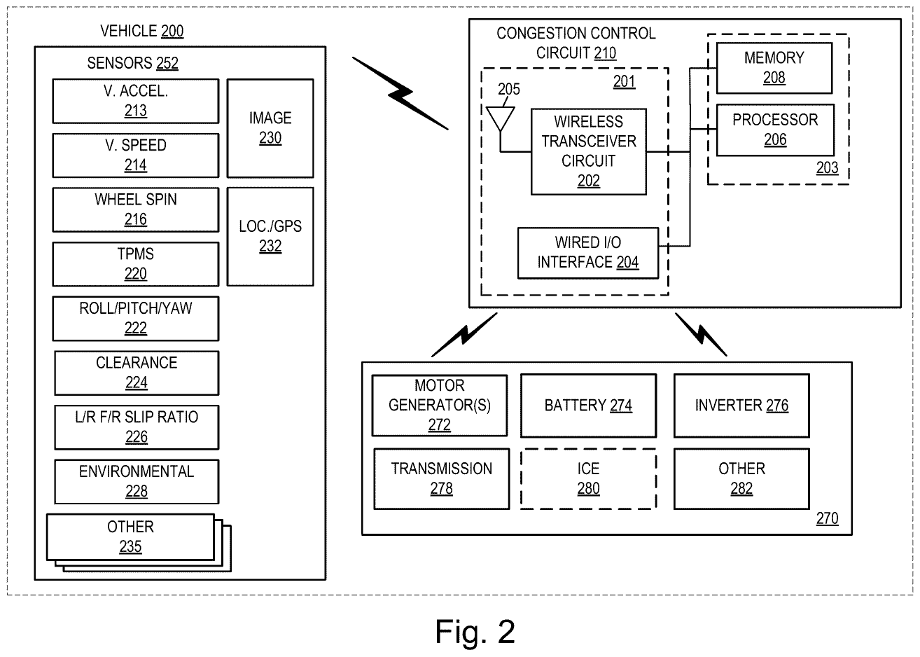

FIG. 2 illustrates an example vehicle 200, in accordance with various embodiments of the presently disclosed technology. Vehicle 200 may be an example of any of the vehicles depicted and described in conjunction with FIGS. 1A-1B.

As depicted, vehicle 200 comprises a congestion control circuit 210, sensors 252, and additional vehicle systems 270. Sensors 252 and additional vehicle systems 270 can communicate with congestion control circuit 210 via a wired or wireless communication interface. Although sensors 252 and additional vehicle systems 270 are depicted as communicating with congestion control circuit 210, they can also communicate with each other. Congestion control circuit 210 can be implemented as an electronic control unit (ECU) or as part of an ECU. In other embodiments, congestion control circuit 210 can be implemented independently of an ECU.

In the specific example of FIG. 2, congestion control circuit 210 includes a communication circuit 201 and a decision circuit 203 (including a processor 206 and a memory 208). Components of congestion control circuit 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to congestion control/congestion control algorithms, data related to VMC tasks, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up congestion control circuit 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with congestion control circuit 210 can include either or both wired and wireless communications. Wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment and to receive radio signals as well. These radio signals can include information of almost any sort that is sent or received by congestion control circuit 210 to/from other entities such as sensors 252, additional vehicle systems 270, other vehicles, connected roadside infrastructure, cloud computing entities, remote servers, etc.

Wired I/O interface 204 can include a transmitter and a receiver (not shown) for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond congestion control. In other implementations, vehicle 200 may comprise additional processing, memory, or communication resources (not depicted) devoted to these other tasks.

Sensors 252 can include, for example, vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 1228 (e.g., to detect salinity or other environmental conditions), image sensor(s) 230, and location sensor(s) 232. Other sensors 235 can also be included as may be appropriate for a given implementation of vehicle 200. For example, other sensors 235 may include proximity sensors such as radar sensors, LiDAR sensors, and sonar sensors, etc.

In some embodiments, image sensor(s) 230 may comprise one or more cameras (e.g., monocular cameras, stereoscopic cameras, RGB cameras, infrared cameras, etc.) configured to obtain image data of an environment surrounding vehicle 200. Such image data (and sometimes in combination with proximity data obtained from proximity sensors) can be used to detect relative positions and behavior of other vehicles, proximity to intersections or corners of a road, etc.

In certain embodiments, location sensor(s) 232 may comprise a global navigation satellite sensor, a global position sensor, or other types of vehicle positioning sensors. Location sensor(s) 232 may be configured to generate location data for vehicle 200 and/or location data for landmarks in the environment surrounding vehicle 200 (e.g., intersections or corners of a road). The location data may comprise precise coordinates (e.g., latitude, longitude, and altitude) of vehicle 200's position or the position(s) of landmark(s) on the Earth's surface.

In some embodiments, one or more of sensors 252 may include their own processing capability to compute the results for additional information that can be provided to congestion control circuit 210. In other embodiments, one or more of sensors 252 may be data-gathering-only sensors that only provide raw data to congestion control circuit 210. In further embodiments, one or more hybrid sensors may be included that provide a combination of raw data and processed data to congestion control circuit 210. Sensors 252 may provide analog outputs, digital outputs, or a combination of both.

Additional vehicle systems 270 can include any of a number of different vehicle components or subsystems used to control or monitor various aspects of vehicle 200 and its performance. For example, additional vehicle systems 270 may include any one or combination of a motor generator system 272, a battery system 274, an inverter 276, and a transmission 278. In implementations where vehicle 200 is a hybrid vehicle, additional vehicle systems 270 may further comprise an internal combustion engine (ICE) 280. Additional vehicle systems 270 may also comprise other vehicle systems 282.

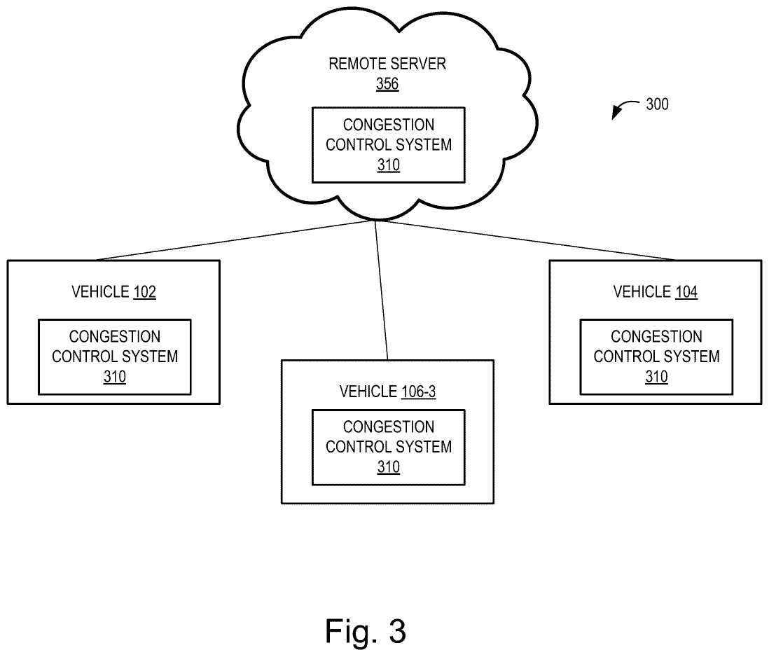

FIG. 3 depicts an example congestion control system 310, in accordance with various embodiments of the presently disclosed technology. Here, congestion control system 310 be an example of congestion control system 110 from FIGS. 1A-1B.

As depicted in FIG. 3, in some embodiments congestion control system 310 may be implemented across a remote server 356 and one or more vehicle traversing a road segment, such as vehicle 102, vehicle 104, and vehicle 106-3 from FIGS. 1A-1B. Such embodiments may be facilitated by a remote environment 300. In some embodiments, remove environment 300 may comprise a cloud-based environment. In other embodiments, remote environment 300 may comprise an edge-based environment. Such an edge-based environment can utilize various types of edge infrastructure, such as roadside/traffic infrastructure, cellular network infrastructure, etc.

In some embodiments, the vehicles across which congestion control system 310 is implemented may comprise a VMC.

Accordingly, as shown, congestion control system 310 may include separate instances within one or more entities of remote environment 300, such as remote server 356, vehicle 102, vehicle 104, and vehicle 106-3. In a further aspect, the entities that implement congestion control system 310 within remote environment 300 may vary beyond transportation-related devices and encompass roadside infrastructure elements. Thus, the set of entities that function in coordination with remote environment 300 may be varied.

In some embodiments, remote environment 300 itself may comprise a dynamic environment that comprises cloud members that migrate into and out of a geographic area.

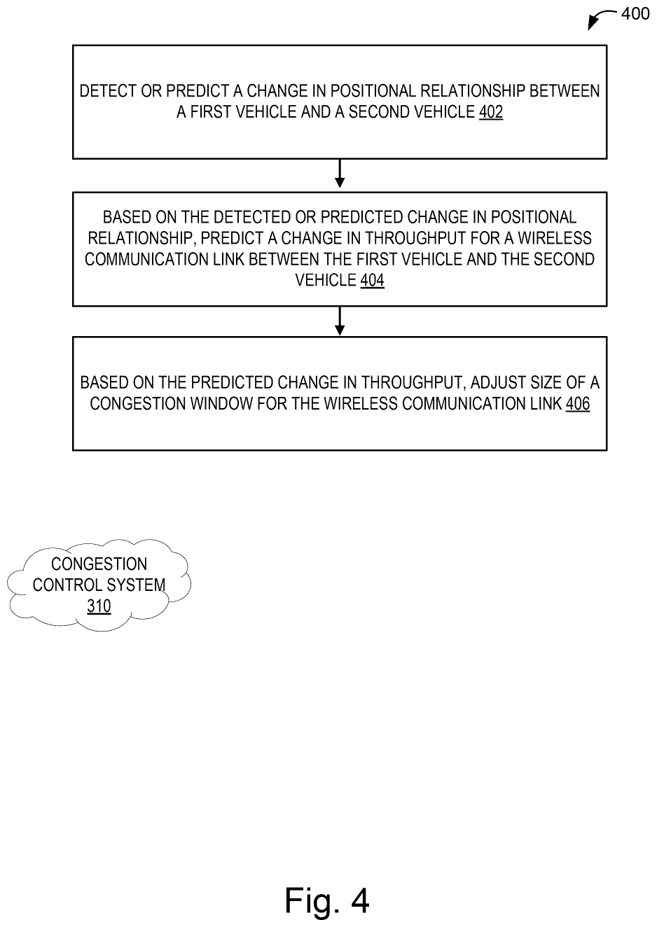

FIG. 4 illustrates an example process 400 that may be performed by congestion control system 310 to adjust congestion window size in response to detecting or predicting changes in driving conditions, in accordance with various embodiments of the presently disclosed technology.

As depicted, congestion control system 310 can perform operation 402 to detect or predict a change in positional relationship between a first vehicle and a second vehicle.

Congestion control system 310 can leverage various data sources to detect or predict the change in positional relationship between the first vehicle and the second vehicle.

These data sources may include sensor data indicative of current or future positions, movement (e.g., lane changes), and driving behavior (e.g., nudging into a lane prior to a lane change, aggressive driving, etc.) of the first vehicle, the second vehicle, and other vehicles proximate the first and second vehicle. The sensor data may be collected/obtained from sensors of the first vehicle (e.g., cameras and proximity sensors, speed sensors, GPS sensors, etc.), sensors of the second vehicle, sensors of the vehicles proximate the first and second vehicle, roadside infrastructure, or any combination thereof.

The data sources leveraged by congestion control system 310 to detect or predict the change in positional relationship between the first vehicle and the second vehicle may also include intent messages transmitted by and among the first vehicle, the second vehicle, other vehicles proximate the first and second vehicles, or any combination thereof. Such intent messages (sometimes shared among vehicles of a VMC, or more generally among autonomous driving systems), may share planned/future driving maneuvers of a transmitting vehicle.

The data sources leveraged by congestion control system 310 to detect or predict the change in positional relationship between the first vehicle and the second vehicle may also include navigation data (e.g., a planned route/destination) of the first vehicle, the second vehicle, other vehicles proximate the first and second vehicle, or any combination thereof. The navigation data may indicate a change in future direction of travel, anticipated lane changes to be made in advance of a planned turn, etc.

In some cases, the detected/predicted change in positional relationship between the first vehicle and the second vehicle may comprise a change in positional relationship that embodiments recognize as typically reducing throughput for a wireless communication link between the first and second vehicles. For example, the detected/predicted change in positional relationship may comprise at least one of: (a) a change in positional relationship that hinders a line of sight between the first vehicle and the second vehicle; (b) over a threshold increase in distance between the first vehicle and the second vehicle; and (c) at least one of the first vehicle and the second vehicle transitioning from a stationary state to a moving state. Here, the change in positional relationship that hinders the line of sight between the first vehicle and the second vehicle may comprise at least one of: (i) a third vehicle merging in between the first vehicle and the second vehicle; and (ii) over a threshold change in heading for the first vehicle relative to a heading of the second vehicle (e.g., where the first vehicle corners a turn before the second vehicle).

In other cases, the detected/predicted change in positional relationship between the first vehicle and the second vehicle may comprise a change in position relationship that embodiments recognize as typically increasing throughput for a wireless communication link between the first and second vehicles. For example, the detected/predicted change in positional relationship may comprise at least one of: (a) a change in positional relationship that un-hinders a line of sight between the first vehicle and the second vehicle; (b) over a threshold decrease in distance between the first vehicle and the second vehicle; and (c) the first vehicle and the second vehicle transitioning from moving states to stationary states.

As depicted, based on the detected or predicted change in positional relationship between the first vehicle and the second vehicle, congestion control system 310 can perform operation 404 to predict a change in throughput for a wireless communication link between the first vehicle and the second vehicle.

As alluded to above, when the detected/predicted change in positional relationship is a change in positional relationship that embodiments recognize as typically decreasing throughput for a wireless communication link between the first and second vehicles, congestion control system 310 can predict a decrease in throughput for the wireless communication link.

By contrast, when the detected/predicted change in positional relationship is a change in positional relationship that embodiments recognize as typically increasing throughput for a wireless communication link between the first and second vehicles, congestion control system 310 can predict an increase in throughput for the wireless communication link.

Based on the predicted change in throughput for the wireless communication link, congestion control system 310 can perform operation 406 to adjust size of a congestion window for the wireless communication link.

As alluded to above, when congestion control system 310 predicts a decrease in throughput, congestion control system 310 can decrease size of the congestion window.

By contrast, when congestion control system 310 predicts an increase in throughput, congestion control system 310 can increase size of the congestion window, or in some cases, reduce a rate of decrease in size for the congestion window (i.e., decrease congestion window size more slowly).

In some implementations, after adjusting the size of the congestion window, congestion control system 310 can execute further operations to: (1) detect the first vehicle and the second vehicle have both come to stationary states, are within a threshold distance of each other, and have an unobstructed line of sight to each other; and (2) responsive to detecting the steady-state from (1), control size of the congestion window in accordance with a default congestion control algorithm of a communication protocol governing the wireless communication link. As alluded to above, in the detected steady-state from (1), a default congestion control algorithm of the communication protocol may be appropriate as there are no dynamic, throughput-impacting driving conditions involved. The communication protocol may comprise various types of congestion control-based network protocols, including the Transmission Control Protocol (TCP). In other implementations, the communication protocol may comprise an application layer protocol such as the QUIC protocol, the GRPC protocol, HTTP protocol(s), the TLS protocol, the MQTT protocol, etc.

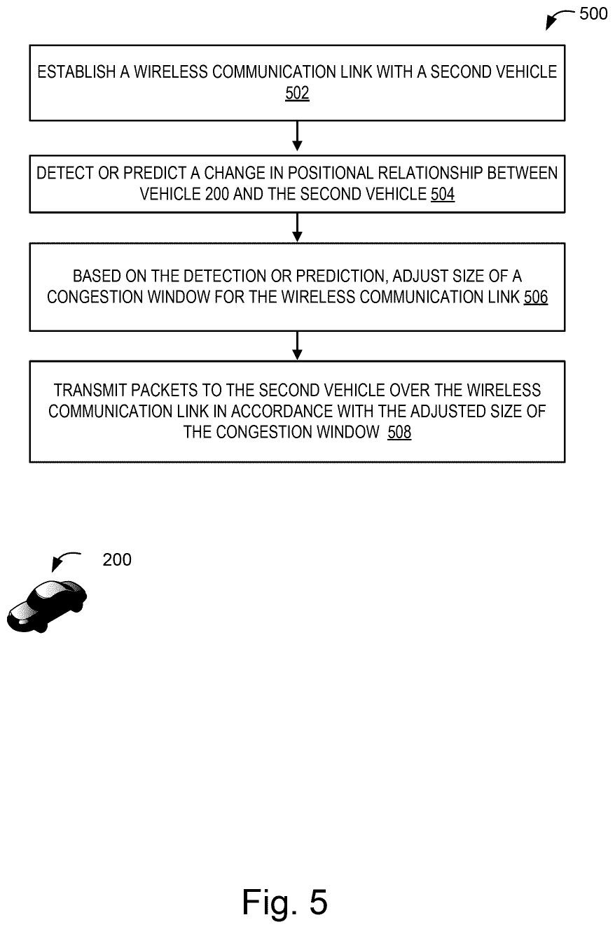

FIG. 5 illustrates an example process 500 that may be performed by vehicle 200 to adjust congestion window size in response to detecting or predicting changes in driving conditions, in accordance with various embodiments of the presently disclosed technology.

As depicted, vehicle 200 can perform operation 502 to establish a wireless communication link with a second vehicle. The wireless communication link may be established in accordance with various communication protocols (e.g., TCP, HTTP, QUIC, GRPC, MQTT, etc.).

Vehicle 200 can perform operation 504 to detect or predict a change in positional relationship between vehicle 200 and the second vehicle. Vehicle 200 may perform this operation in the same/similar manner as described in conjunction with operation 402 from FIG. 4.

Based on the detected or predicted change in positional relationship between vehicle 200 and the second vehicle, vehicle 200 can perform operation 506 to adjust size of a congestion window for the wireless communication link. Vehicle 200 may perform this operation in the same/similar manner as described in conjunction with operations 404 and 406 from FIG. 4.

For example, when the detected/predicted change in positional relationship is a change in positional relationship that embodiments recognize as typically decreasing throughput for a wireless communication link between vehicle 200 and the second vehicle, vehicle 200 can decrease size of the congestion window to more appropriately fit a (predicted/anticipated) decrease in throughput.

By contrast, when the detected/predicted change in positional relationship is a change in positional relationship that embodiments recognize as typically increasing throughput for a wireless communication link between vehicle 200 and the second vehicle, vehicle 200 can increase size of the congestion window to more appropriately fit a (predicted/anticipated) increase in throughput.

Vehicle 200 can perform operation 508 to transmit packets to the second vehicle over the wireless communication link in accordance with the adjusted size of the congestion window. As alluded to above, vehicle 200 may transmit these packets in accordance with a communication protocol (e.g., TCP) governing the wireless communication link.

As described above, FIG. 6 illustrates a plot 600 of example test data correlating throughput of a wireless communication link between two vehicles (plotted on the y-axis) as a function of distance (plotted on the x-axis) between the two vehicles. As shown in plot 600, throughput generally increases with increasing proximity between the two vehicles. However, in certain cases throughput may remain low when the two vehicles are close together. This may be the case when a line of sight between the two vehicles is hindered (e.g., because a third vehicle is obstructing the line of sight, or headings of the vehicles are different such as when one vehicle corners a turn before the other vehicle). This may also be the case when the two vehicles are moving, or more acutely, moving away from each other.

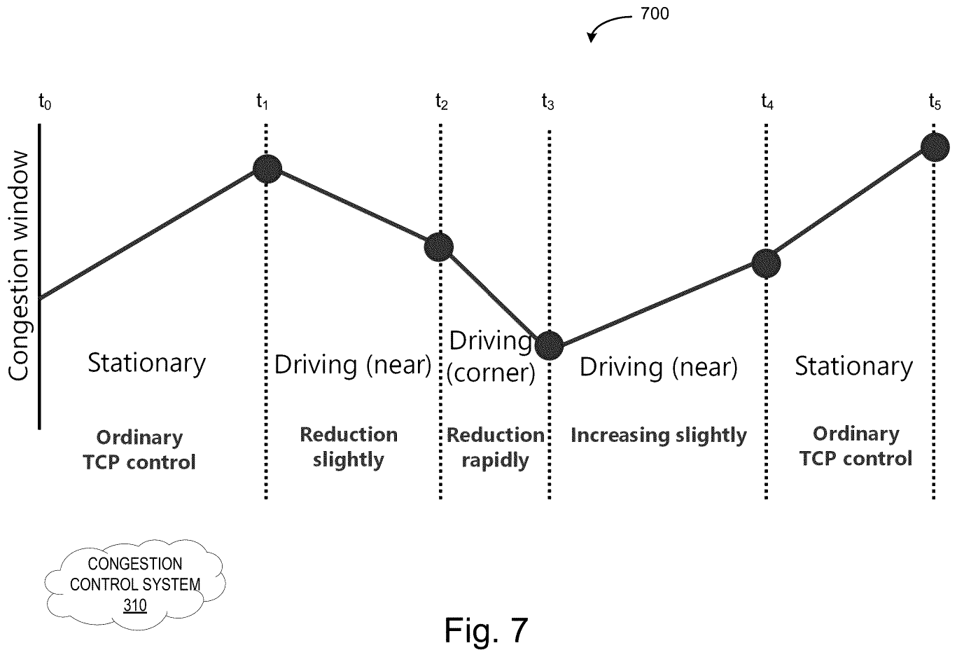

FIG. 7 illustrates an example graph 700 illustrating how congestion control system 310 may adjust congestion window size over time in response to detecting or predicting changes in driving conditions.

Namely, the y-axis of graph 700 plots congestion window size for a wireless communication link between two vehicles. The x-axis of graph 700 plots time.

As depicted, from time t₀ to time t₁, the two vehicles may be stationary (e.g., waiting at a traffic light). In certain cases, the two vehicles may also be relatively close (e.g., within a threshold distance of each other) and have an un-hindered/un-obstructed line of sight to each other. Accordingly, under this steady-state condition congestion control system 310 may utilize a default congestion control algorithm (e.g., the default TCP congestion control algorithm) to control congestion window size.

As depicted, at time t₁, the two vehicles may start to move (e.g., after a traffic light changes from red to green). As the presently disclosed technology appreciates, this change in driving conditions tends to reduce throughput for a wireless communication link. Accordingly, at (or in some cases slightly before) time t₁, congestion control system 310 may transition from using a default congestion control algorithm to start reducing size of the congestion window at a first rate.

As depicted, at time t₂, one of the vehicles may turn around a corner—thus hindering the line of sight between the two vehicles. As the presently disclosed technology appreciates, this change in driving conditions can further reduce throughput for the wireless communication link. Accordingly, at (or in some cases slightly before) time t₂, congestion control system 310 may start reducing size of the congestion window at a second, faster rate.

As depicted, at time t₃, the other of the two vehicles may also turn around the corner—thus un-hindering the line of sight between the two vehicles. As the presently disclosed technology appreciates, this change in driving conditions may increase throughput for the wireless communication link. Accordingly, at (or in some cases slightly before) time t₃, congestion control system 310 may start increasing size of the congestion window at a first rate.

As depicted, at time t₄, the two vehicles may again transition to stationary states. As at time t₀, the two vehicles may be relatively close (e.g., within a threshold distance of each other) and have an un-hindered/un-obstructed line of sight to each other. Accordingly, under this steady-state condition congestion control system 310 may again utilize the default congestion control algorithm (e.g., the default TCP congestion control algorithm) to control congestion window size from time t₄ to time t₅. As depicted, this may involve increasing size of the congestion window at a second, faster rate.

In various implementations, congestion control system 310 can leverage machine learning to learn to adjust congestion window size more effectively based on driving conditions. For example, congestion control system 310 can measure the success of data transmission and intelligently adjust congestion window size. For example, one of the two vehicles waiting for a red light in the rightmost lane may turn right. In such a case, congestion control system 310 may initially decrease congestion window size slightly. If however the data transmission fails, congestion control system 310 can learn that the congestion window should be reduced more rapidly.

It may be appreciated that FIG. 7 merely provides an illustrative example of congestion control in accordance with the presently disclosed technology. For example, while the increases/decreases to congestion window size in graph 700 are linear, in other implementations the increases/decreases may be non-linear, or at different rates, etc.

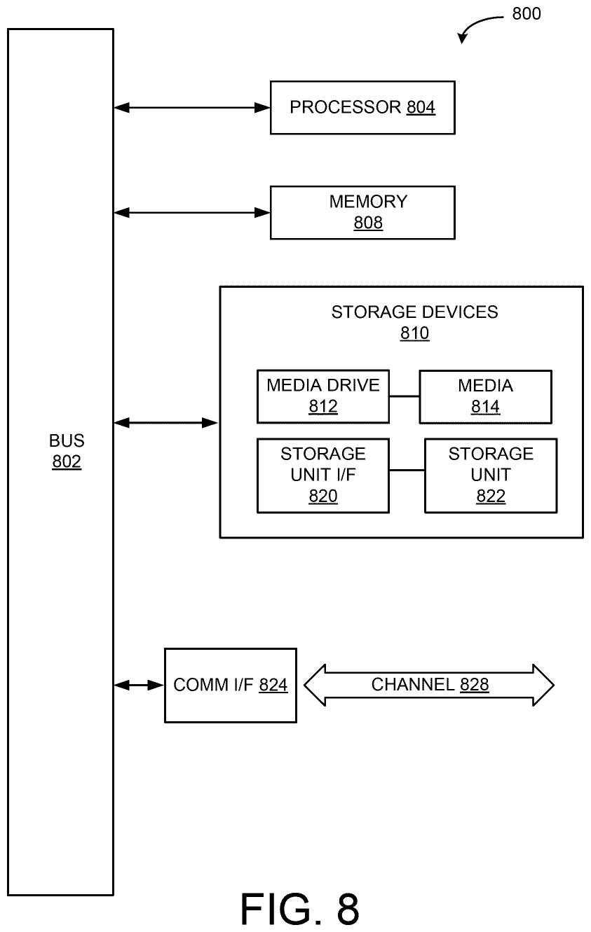

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various embodiments are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. This can include a processor, and/or any one or more of the components making up a user device, a user system, and a non-decrypting cloud service. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing component 800. Such instrumentalities might include, for example, a fixed or removable storage unit 822 and interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
detecting or predicting a change in positional relationship between a first vehicle and a second vehicle;
based on the detected or predicted change in positional relationship, predicting a change in throughput for a wireless communication link between the first vehicle and the second vehicle; and
based on the predicted change in throughput, adjusting size of a congestion window for the wireless communication link.

2. The method of claim 1, wherein the change in positional relationship between the first vehicle and the second vehicle comprises at least one of:
a change in positional relationship that hinders a line of sight between the first vehicle and the second vehicle;
over a threshold increase in distance between the first vehicle and the second vehicle; and
at least one of the first vehicle and the second vehicle transitioning from a stationary state to a moving state.

3. The method of claim 2, wherein the change in positional relationship that hinders the line of sight between the first vehicle and the second vehicle comprises at least one of:
a third vehicle merging in between the first vehicle and the second vehicle; and
over a threshold change in heading for the first vehicle relative to a heading of the second vehicle.

4. The method of claim 2, wherein predicting the change in throughput for the wireless communication link comprises predicting a decrease in throughput.

5. The method of claim 4, wherein adjusting size of the congestion window comprises decreasing size of the congestion window.

6. The method of claim 1, further comprising:
after adjusting the size of the congestion window, detecting the first vehicle and the second vehicle have both come to stationary states, are within a threshold distance of each other, and have an unobstructed line of sight to each other; and
responsive detecting the first vehicle and the second vehicle have both come to stationary states, are within the threshold distance of each other, and have an unobstructed line of sight to each other:
controlling size of the congestion window in accordance with a default congestion control algorithm of a communication protocol governing the wireless communication link.

7. The method of claim 6, wherein the communication protocol comprises a congestion control-based network protocol.

8. The method of claim 6, wherein controlling size of the congestion window in accordance with the default congestion control algorithm comprises increasing size of the congestion window.

9. The method of claim 1, wherein detecting or predicting the change in positional relationship between the first vehicle and the second vehicle comprises predicting the change in positional relationship based on at least one of:
intent messages from at least one of the first vehicle, the second vehicle, and a third vehicle predicted to merge in between the first vehicle and the second vehicle;
detected driving behavior of at least one of the first vehicle, the second vehicle, and the third vehicle; and
navigation data from at least one of the first vehicle and the second vehicle.

10. The method of claim 9, wherein at least two of the first vehicle, the second vehicle, and the third vehicle form a vehicular micro-cloud (VMC) and the intent messages are transmitted among members of the VMC.

11. A vehicle comprising:
one or more processors; and
memory storing machine-readable instructions that, when executed by the one or more processors, cause the vehicle to:
establish a wireless communication link with a second vehicle;
detect or predict a change in positional relationship between the vehicle and the second vehicle;
based on the detection or prediction, adjust size of a congestion window for the wireless communication link; and
transmit packets to the second vehicle over the wireless communication link in accordance with the adjusted size of the congestion window.

12. The vehicle of claim 11, wherein the change in positional relationship between the vehicle and the second vehicle comprises at least one of:
a change in positional relationship that un-obstructs a line of sight between the vehicle and the second vehicle;
over a threshold decrease in distance between the vehicle and the second vehicle; and
the vehicle and the second vehicle transitioning from moving states to stationary states.

13. The vehicle of claim 12, wherein adjusting size of the congestion window comprises at least one of:
increasing size of the congestion window; and
reducing a rate of decrease in size for the congestion window.

14. The vehicle of claim 11, wherein the memory stores further instructions, that when executed by the one or more processors, cause the vehicle to:
based on the detected or predicted change in positional relationship between the vehicle and the second vehicle, predict a change in throughput for the wireless communication link;
wherein adjusting size of the congestion window is based on the predicted change in throughput.

15. A system comprising:
one or more processors; and
memory storing machine-readable instructions that, when executed by the one or more processors, cause the system to:
detect or predict a change in positional relationship between a first vehicle and a second vehicle;
based on the detected or predicted change in positional relationship, predict a change in throughput for a wireless communication link between the first vehicle and the second vehicle; and
based on the predicted change in throughput for the wireless communication link, adjust size of a congestion window for the wireless communication link.

16. The system of claim 15, wherein the change in positional relationship between the first vehicle and the second vehicle comprises at least one of:
a change in positional relationship that hinders a line of sight between the first vehicle and the second vehicle;
over a threshold increase in distance between the first vehicle and the second vehicle; and
at least one of the first vehicle and the second vehicle transitioning from a stationary state to a moving state.

17. The system of claim 16, wherein the change in positional relationship that hinders the line of sight between the first vehicle and the second vehicle comprises at least one of:
a third vehicle merging in between the first vehicle and the second vehicle; and
over a threshold change in heading for the first vehicle relative to a heading of the second vehicle.

18. The system of claim 16, wherein:
predicting the change in throughput for the wireless communication link comprises predicting a decrease in throughput; and
adjusting size of the congestion window comprises decreasing size of the congestion window.

19. The system of claim 15, wherein the change in positional relationship between the first vehicle and the second vehicle comprises at least one of:
a change in positional relationship that un-hinders a line of sight between the first vehicle and the second vehicle;
over a threshold decrease in distance between the first vehicle and the second vehicle; and
the first vehicle and the second vehicle transitioning from moving states to stationary states.

20. The system of claim 19, wherein:
predicting the change in throughput for the wireless communication link comprises predicting an increase in throughput; and
adjusting size of the congestion window comprises at least one of:
increasing size of the congestion window; and
reducing a rate of decrease in size for the congestion window.
